(19) United States
(12) Patent Application Publication
(10) Pub. No.: US 2006/0020424 A1
(43) Pub. Date: Jan. 26, 2006

(54) Apparatus and method for analyzing trends with values of interest

(76) Inventor: Carl Quindel, Milwaukee, WI (US)

Correspondence Address: EDWARDS & ANGELL, LLP, P.O. BOX 55874, BOSTON, MA, 02205, US

(21) Appl. No.: 11/185,499

(22) Filed: Jul. 20, 2005

Related U.S. Application Data
(60) Provisional application No. 60/589,612, filed on Jul. 20, 2004.

(51) Int. Cl. G06F 15/00

(52) U.S. Cl. 702/183

(57) ABSTRACT

A trend analysis system accesses a database of values related to a plurality of events and a geographical map of a region of interest, the map including boundary divisions that represent a type of event. A user inputs a preliminary set of parameters to categorize the type of event and allows the trend analysis system to create assumptions related to the type of event, the assumptions being related to a spatial decay rate for the influence on a value of interest associated with each event. The trend analysis system determines an assumptions variable based upon the assumptions and prepares a density map based upon the assumptions variable, the type of event, the geographical map, the preliminary set and the database of values. The density map has large values in regions with a large numbers of events and small values in regions with a small number of events.

### CROSS-REFERENCE TO RELATED APPLICATION

This application claims priority to U.S. Provisional Patent Application No. 60/589,612 filed Jul. 20, 2004, which is incorporated herein by reference.

### BACKGROUND OF THE INVENTION

1. Field of the Invention

The subject disclosure relates to methods and systems for analyzing historical data to identify geographic regions of interest. More particularly, the improved methods and systems analyze a database of events such as a real estate sales to determine a rate of decay for each event's influence within a defined time period such that trend direction can be predicted. During planning, site selection, and risk assessments, the following methods and systems are utilized as decision-making tools.

2. Background of the Related Art

Trend watching has been widely practiced by amateurs and professionals in countless applications. Realtors and real estate investors have long utilized sales of comparable properties as the basis for appraising fair value and determining price direction. The proliferation of the Internet has caused great optimism for the widespread dissemination of home sale information and inventory to allow for quick and easy comparisons. Despite the increased access to information by all parties involved, the typical evaluation process is still largely dependent upon the individuals correctly assessing how to translate the parameters for a sale of one property to a potential sale of another. Moreover, emotion and conflicting motivation between involved parties can distort the evaluation to result in a highly inefficient, volatile marketplace.

The largely instinctive process described above has further drawbacks in that no problem solving framework exists that allows solving similar problems in different areas. For example, it would be useful for police departments to quickly and efficiently recognize trends in illegal activity within their districts with more accessible, accurate, and meaningful analysis. Illegal activity is similar to real estate sales in that the event has a geographic location with a sphere of interest and a quantifiable level of seriousness or cost. Typically, police departments rely on anecdotal and statistically insufficient spatial analysis of their databases to determine how resources should be assigned.

### SUMMARY OF THE INVENTION

In view of the above, a need exists for a system and method that quickly and easily provides trend analysis on specific historical events within a defined area. These decision making tools provide opportunities for pattern recognition, isolation of areas fitting particular criteria, and analysis of correlation between separate databases inside confined regions of interest. The improved system and method also allow for prediction of future performance.

The subject technology provides for methods and system for analyzing trends in a region by calculating a frequency of an event and evaluating each events influence on the surrounding region based upon a spatial rate of decay for each event's influence. In addition, the methods and systems disclosed herein provide data related to the event's variability and future trends.

It is an object of the present technology to graphically depict on maps the frequency of occurance or density of events. It is another object of the present disclosure to map derivative values of the density of events to track changes, rates of change, and the changes in the rates of change of the density of events. This can be used to predict future performance.

It is an object of the present technology to graphically depict on maps the effect of each of the events associated value of interest upon a similar event's value of interest inside a specified region, or the values of interest defined by weighted influence. It is another object of the present disclosure to map derivative values of these weighted values of interest to track changes, rates of change, and changes in the rates of change of the weighted values of interest. This can also be used to predict future performance.

One goal of these improved methods and systems is to replace or enhance the current software used to analyze crime patterns with algorithms that deal specifically with spatial, time-sensitive influences of criminal events quantifiable by a measure of resources or degree of violence.

In addition to analysis on real estate sales and criminal events, these methods and systems have the ability, without limitation, to satisfy the needs of the following customers: those who already have a use for a space, but wish to locate a geographic location satisfying specific criteria (i.e. demographics, traffic patterns, and the like); for real estate investors or those buying real estate in a new unknown market these decision-making tools serve as a guide; city government can use this type of analysis to decide where their economic resources can most influence a region; allows for departments of economic development to market specific locations to commercial developers searching for a site satisfying a particular profile; and nonprofit organizations can use statistics to follow their progress or show the need for their services.

These objects are achieved by a trend analysis system that accesses a database of values related to a plurality of events, a geographical map of the region of interest, and a user-defined set of data categorizing the type of analysis. A user inputs a preliminary set of parameters to categorize the type of event and allows the trend analysis system to create assumptions related to the type of analysis for which to undertake. The trend analysis system determines an assumptions variable based on the user-defined parameters and produces a spatial decay rate of a value of interest associated with each event accordingly. The trend analysis system prepares an event density map based upon these assumptions, the user-defined type of event, the geographical map, the preliminary set of events and the database of values. The event density map has large values in regions with a large numbers of events and small values in regions with a small number of events.

In another embodiment, the present technology provides a trend analysis system for analyzing historical data to model future trends. This includes an assumption section for receiving data-related assumptions concerning an event and a construction section for creating a plurality of variables and equations based on the assumptions. A calibration section solving for the variables and a mapping section applies the equations to the historical data to generate a map or series of maps indicating a spatial zone of influence within a defined time period such that a trend direction is identified. The trend analysis system is particularly useful when the events are real estate sales or criminal acts.

In another embodiment, the present technology provides a method for analyzing a trend in real estate including the steps of accessing a geographical map of a region of interest, the map including, boundary divisions that represent a type of event. A user enters a preliminary set of inputs to categorize the type of event and accesses a database of values associated with a plurality of events. Assumptions are created relating to the type of event and a spatial decay rate of a value of interest associated with each event for determining an assumptions function. Based upon the spatial decay rate, the assumptions function, and the preliminary set of inputs, a specific influence function can be calculated to ascertain the influence of each event on the surrounding region.

In another embodiment, the present technology provides a computer-readable medium whose contents cause a computer system to perform a method for analyzing and recognizing trends based upon a spatial rate of decay of an influence of an event from the event's location. Preferably, a computer system utilizes the computer-readable medium to access a geographical map of a region of interest, the map including boundary divisions that represent a type of event and receive a preliminary set of user-defined inputs to categorize the type of event. The computer system also accesses a database of values related to a plurality of events and creates assumptions related to the type of event, the assumptions being related to a spatial decay rate of a value of interest associated with each event. Based upon the assumptions, an assumptions function is determined. Once a nucleus for the plurality of events has been calculated, a specific influence function can be determined based upon the preliminary inputs and the assumptions function.

In another embodiment, the present technology provides a trend analysis system for analyzing historical data to model future trends including an assumption section for receiving data related to at least one assumption concerning an event, a construction section for creating a plurality of variables and equations based on the assumptions, and a calibration section for fitting the variables to historical patterns and applying the equations to the data.

In another embodiment, the present technology provides a computer-readable medium whose contents cause a computer system to perform a method for analyzing and recognizing trends based upon a rate of decay of an influence of an event, the computer system having a server program and a client program with functions for invocation by performing the steps of accessing a historical data set relating to a type of event, entering a preliminary set of user-defined inputs to categorize the type of event, creating assumptions related to the type of event, the assumptions being related to an influence for a value of interest associated with each event, determining an assumptions function based upon the assumptions, and determining a specific influence function based upon the assumptions function.

Preferably, the subject technology generates reports for analysis to find quantitatively defferent areas that smoothly transition onto each other. In other words, the report finds the path across a particular area that has the largest change in value. Looking at change in value over time, one can understand the transition stages with respect to this characteristic. By analyzing the movement, patterns can be recognized.

Preferably, the subject technology also correlates different data sets. Overlaying and analysis of many data sets is also possible. By normalizing each respective mapping of the data sets, the subject technology analyzes the types of similarities in values, change in values, other derivative mappings, mean and standard deviation mapping and the like. In one application, correlating different data sets overcomes potential lack of data problems. Still further, if one can find a database that has a high correlation to another more available database, one can use them interchangeably to learn about the other.

It should be appreciated that the present invention can be implemented and utilized in numerous ways, including without limitation as a process, an apparatus, a system, a device, a method for applications now known and later developed or a computer readable medium. These and other unique features of the system disclosed herein will become more readily apparent from the following description and the accompanying drawings.

### BRIEF DESCRIPTION OF THE DRAWINGS

This patent or application file contains at least one drawing executed in color. Copies of this patent or patent application publication with color drawing(s) will be provided by the Office upon request and payment of the necessary fee.

So that those having ordinary skill in the art to which the disclosed system appertains will more readily understand how to make and use the same, reference may be had to the drawings wherein:

FIG. 1 is a functional diagram showing an environment having a vendor showcase system implementing the present invention;

FIG. 2 is a somewhat schematic diagram of a system implementing the present invention;

FIGS. 3A and 3B are a flow diagram of a process performed by the system of FIG. 2 with matching circles A-A to illustrate how to properly connect FIGS. 3A and 3B;

FIG. 3C is a somewhat schematic conversion of a non-uniform pixel to a uniform pixel as performed by the system of FIG. 2;

FIG. 4 is a graphical depiction of two events that are analyzed by the trend analysis system of FIG. 2;

FIG. 5 is a graphical example of two events with overlapping nuclei;

FIG. 6 is an exemplary density of event map; and

FIGS. 7A-H are an exemplary time sequence of a density of event map from the years 1996 to 2003.

### DETAILED DESCRIPTION OF PREFERRED EMBODIMENTS

The present invention overcomes many of the prior art problems associated with analyzing and predicting trends. The advantages, and other features of the system disclosed herein, will become more readily apparent to those having ordinary skill in the art from the following detailed description of certain preferred embodiments taken in conjunction with the drawings which set forth representative embodiments of the present invention and wherein like reference numerals identify similar structural elements.

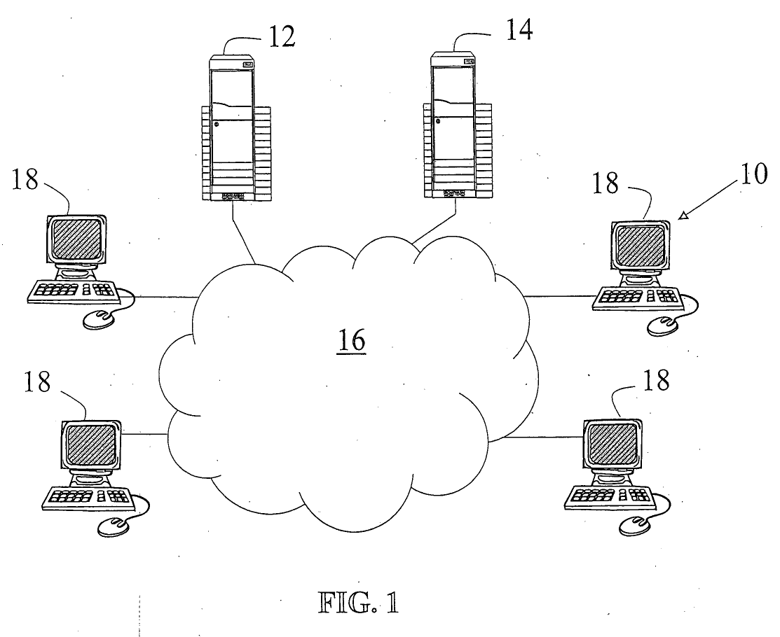

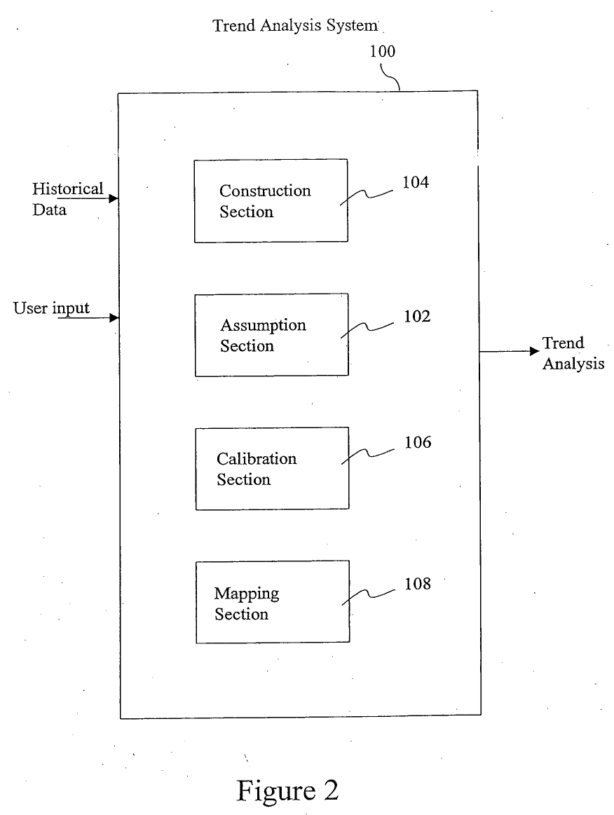

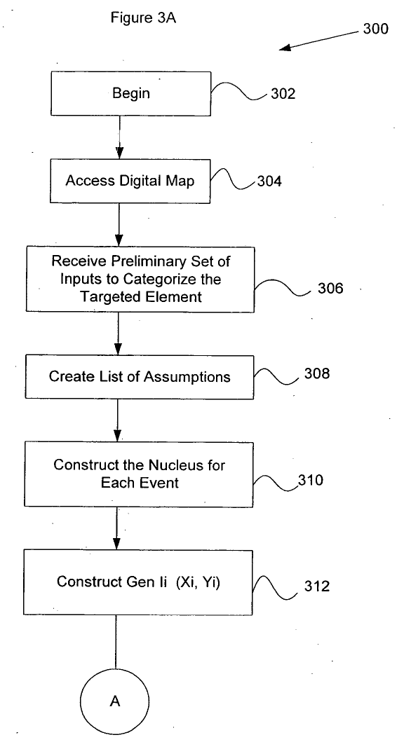

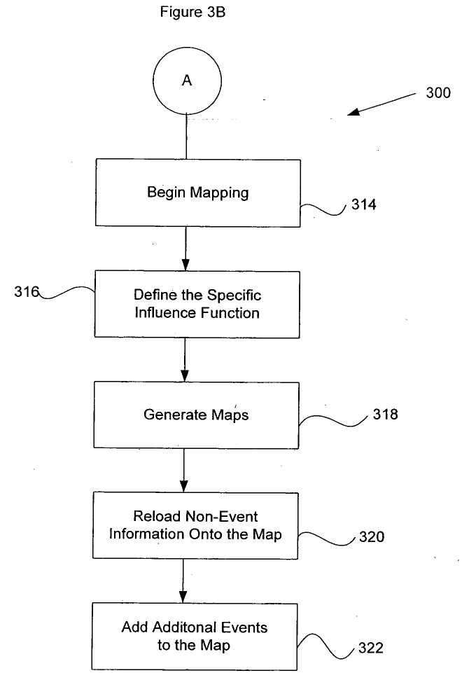

Referring now to the FIG. 1, there is shown a block diagram of an environment 10 with a trend analysis system 100 (also see FIG. 2) for real estate sales embodying and implementing the methodology of the present disclosure. The environment 10 connects on-line users (real estate agents, home sellers, home buyers, mortgage brokers, appraisers and the like) with the trend analysis system 100. Preferably, the environment 10 requires paid subscription to access the trend analysis system 100. The following discussion describes the structure of the environment 10 but further discussion of the trend analysis system 100, related application programs and data modules that embody the methodology of the present invention is described elsewhere herein. The environment 10 includes one or more servers 12, 14 which communicate across a distributed computer network 16 via communication channels, whether wired or wireless, as is well known to those of ordinary skill in the pertinent art. In the preferred embodiment, the distributed computer network 16 is the Internet. For the Internet, the preferred method of accessing information is the World Wide Web because navigation is intuitive and does not require technical knowledge. For simplicity, only server 12 and server 14 are shown. Server 12 can host multiple Web sites and house multiple databases necessary for the proper operation of the trend analysis system 100 in accordance with the subject invention. Server 14 can also host multiple Web sites and house multiple databases such as a Multiple Listing Database for access by Server 12.

Servers 12, 14 are any of a number of servers known to those skilled in the art that are intended to be operably connected to a network so as to operably link to a plurality of client computers or clients 18, 20 via the distributed computer network 16. As an illustration, servers 12, 14 typically include a central processing unit including one or more microprocessors such as those manufactured by Intel or AMD, random access memory (RAM), mechanisms and structures for performing I/O operations, a storage medium such as a magnetic hard disk drive(s), and an operating system for execution on the central processing unit. The hard disk drive of the servers 12, 14 may be used for storing data, client applications and the like. The hard disk drive(s) of the servers 12, 14 also are typically provided for purposes of booting and storing the operating system, other applications or systems that are to be executed on the server, paging and swapping between the hard disk and the RAM.

It is envisioned that the servers 12, 14 can utilize multiple servers in cooperation to facilitate greater performance and stability of the subject invention by distributing memory and processing as is well known. Distributed computer network 12 may include any number of network systems well known to those skilled in the art. For example, distributed computer network 12 may be a combination of local area networks (LAN) or wide area networks (WAN), as is well known.

The environment 10 also includes a plurality of clients 18 such as desktop computers, laptop computers, personal digital assistants, cellular telephones and the like. The clients 18 allow users to access information on the servers 12, 14. For simplicity, only four clients 18 are shown. The clients 18 have displays and an input device(s) as would be appreciated by those of ordinary skill in the pertinent art. The display may be any of a number of devices known to those skilled in the art for displaying images responsive to outputs signals from a portion of the clients 18. Such devices include but are not limited to cathode ray tubes (CRT), liquid crystal displays (LCDS), plasma screens and the like. Although a simplified diagram is illustrated in FIG. 1 such illustration shall not be construed as limiting the present invention to the illustrated embodiment. It should be recognized that the signals being outputted from the client 18 can originate from any of a number of devices including PCI or AGP video boards or cards mounted within the housing of the computers 14, 16 that are operably coupled to the microprocessors and the displays of the clients 18.

Clients 18 typically provide user access to the environment 10. A plurality of users can share the same client 18 and cookie technology can be utilized to facilitate access to the environment 10 and, thereby, the trend analysis system 100. Preferably, an unlimited number of users can utilize the trend analysis system 100 within the environment 10 simultaneously.

The clients 18 are also prefereably equipped with an input device(s) as is known to those skilled in the art which can be used to provide input signals for control of applications programs and other programs such as the operating system being executed on the clients 18. In illustrative embodiments, the input device preferably comprises a switch, a slide, a mouse, a track ball, a glide point or a joystick, a microphone or other such device (e.g., a keyboard having an integrally mounted glide point or mouse) by which a user can input control signals and other commands. Although the use of a keyboard as an input device is not described further herein, it is within the scope of the present invention for the input device to comprise any of a number of keyboards known to those skilled in the art, wherein the control signals or commands for implementing and interacting with the vendor showcase system and the applications program embodying such methodology can be implemented in the form of discrete commands via a keyboard.

The clients 18 typically include a central processing unit including one or more micro-processors, random access memory (RAM), mechanisms and structures for performing I/O operations (not shown), a storage medium such as a magnetic hard disk drive(s), a device for reading from and/or writing to removable computer readable media and an operating system for execution on the central processing unit. According to one embodiment, the hard disk drive of the clients 18 is for purposes of booting and storing the operating system, other applications or systems that are to be executed on the computer, paging and swapping between the hard disk and the RAM and the like. In one embodiment, the application programs reside on the hard disk drive for performing the functions in accordance with the trend analysis system 100. In another embodiment, the hard disk drive simply has a browser for accessing an application hosted within the distributed computing network 16 to perform the functions of the trend analysis system 100. The clients 18 can also utilize a removable computer readable medium such as a CD or DVD type of media that is inserted therein for reading and/or writing to the removable computer readable media.

It is envisioned that the trend analysis system 100 provides for administration and security maintenance. Therefore, although each user has access to a user interface, each group's access is controlled. The interface specifies which aspects of the program can be accessed, and at what level. Such limitations of functionality are well known to those skilled in the art and therefore are not further described herein.

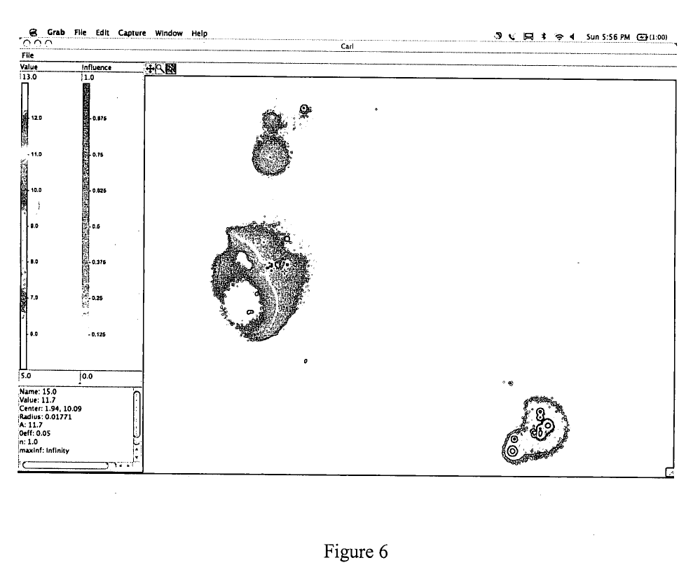

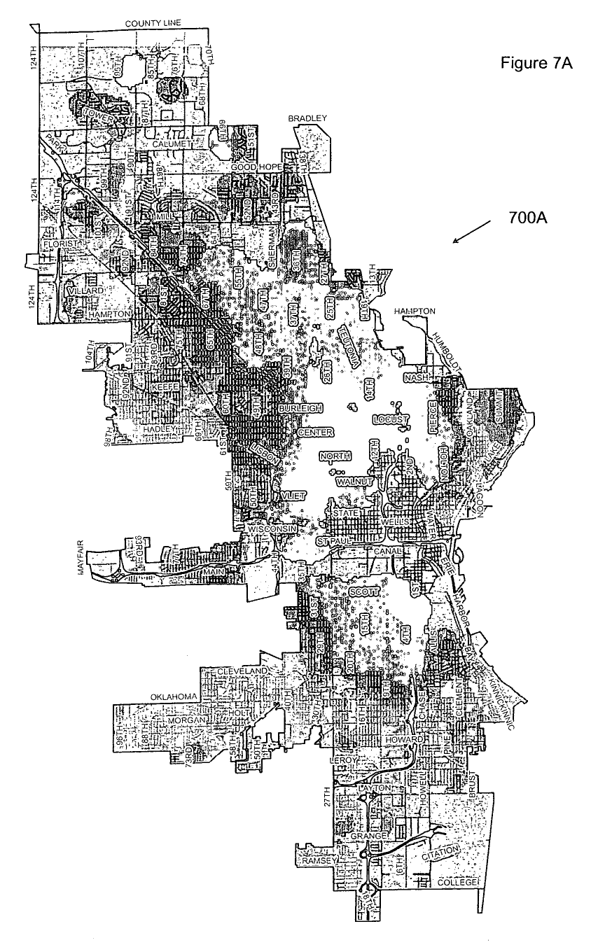

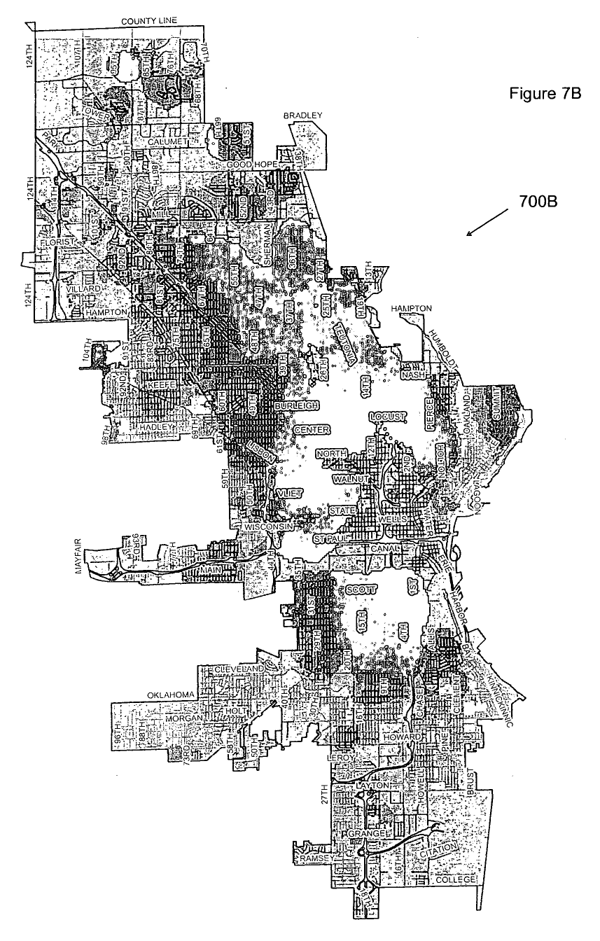

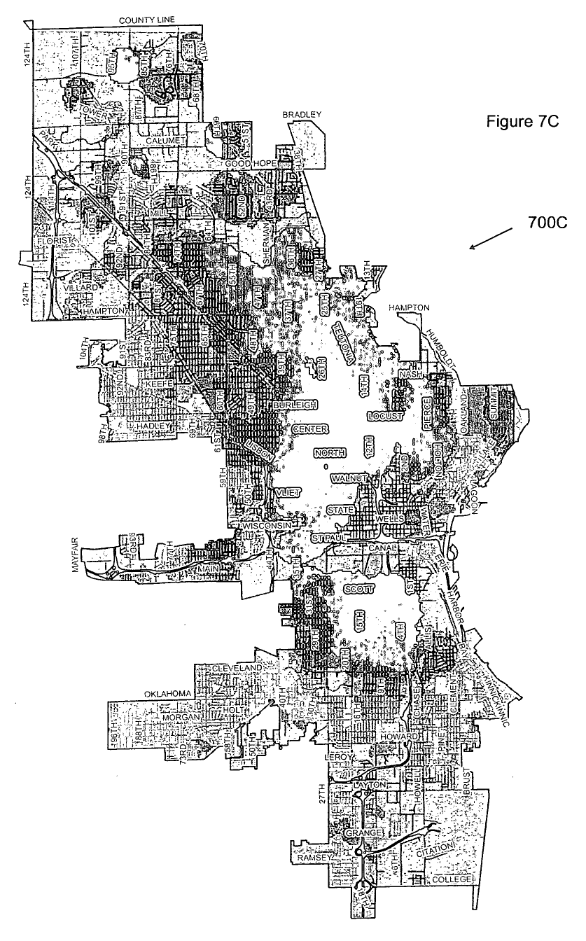

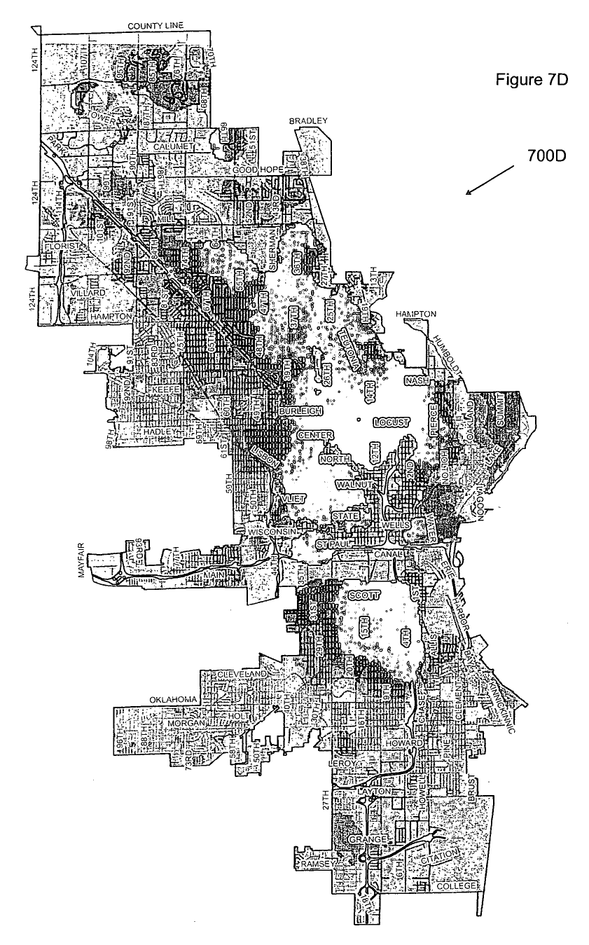

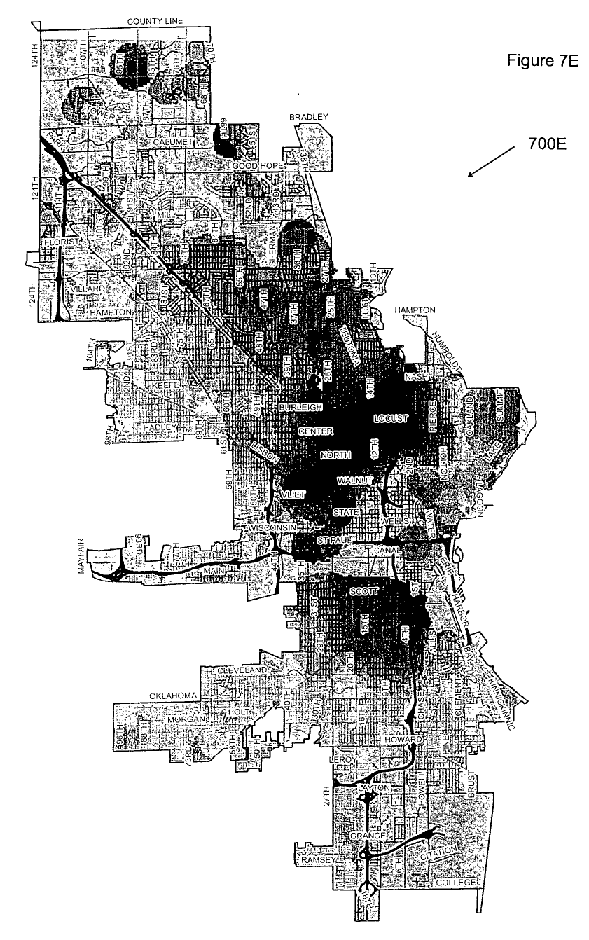

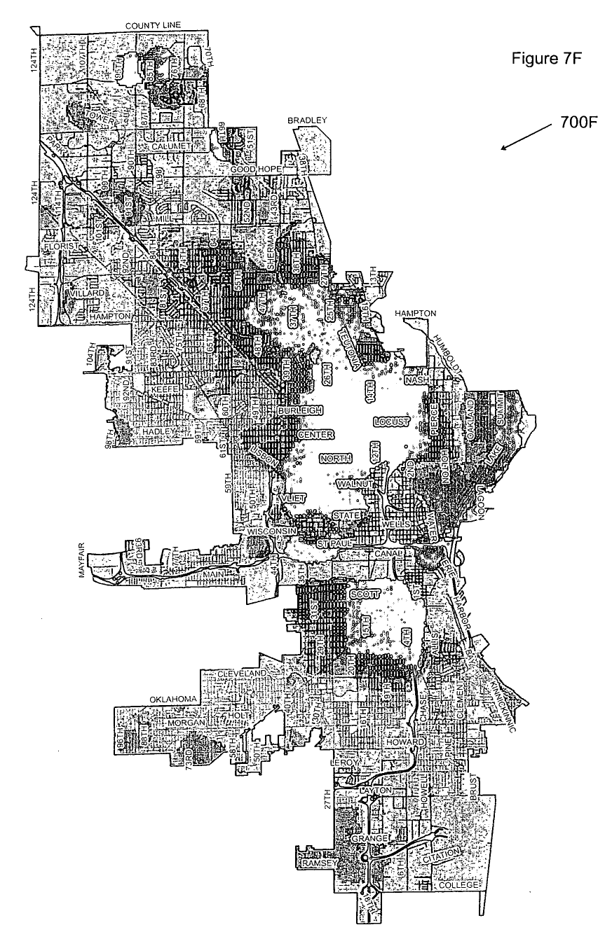

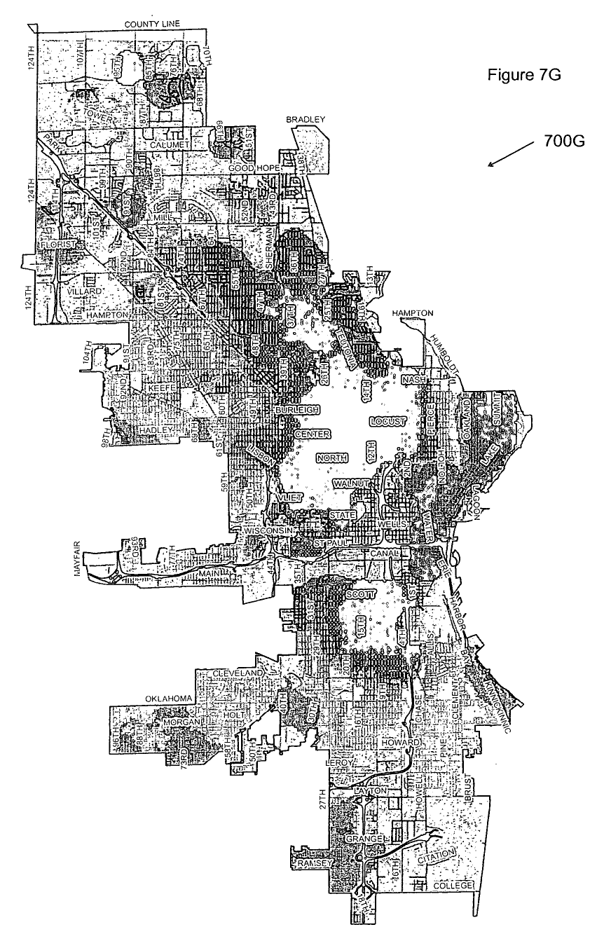

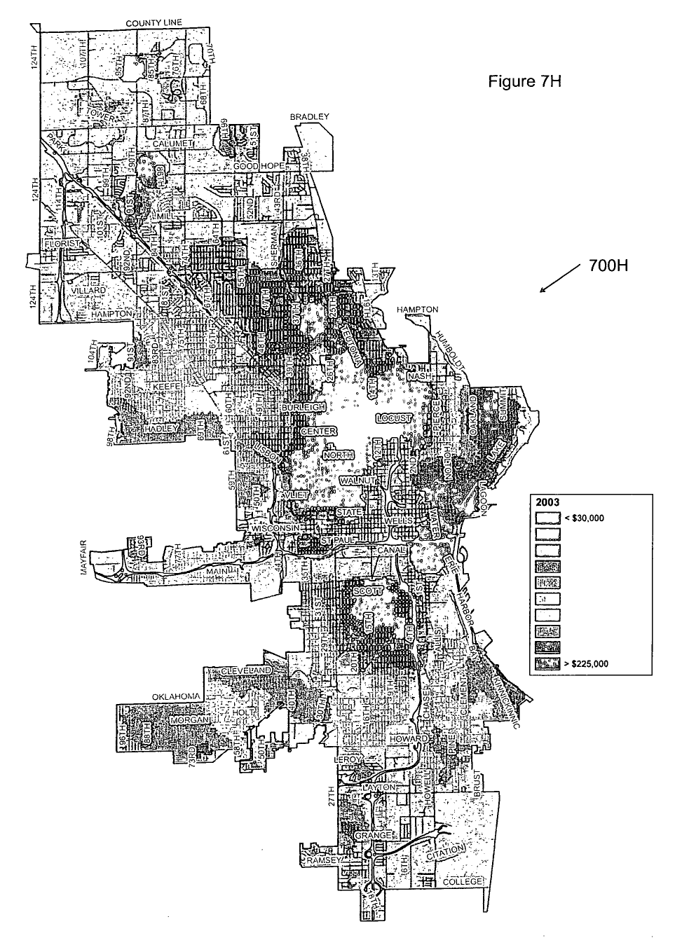

Referring to FIG. 2, a more detailed view of the trend analysis system 100 is shown. The trend analysis system 100 receives historical data and user input to generate a plurality of graphical displays or maps as described below with respect to FIGS. 6 and 7. An assumption section 102 of the trend analysis system 100 receives user input related to one or more assumptions about the specific event being studied, i.e., about real estate sales. Based upon the assumptions, a construction section 104 creates a plurality of variables and equations. Once the calibration section 106 has solved for the variables, the mapping section 108 can apply the equations to the historical data to generate the maps.

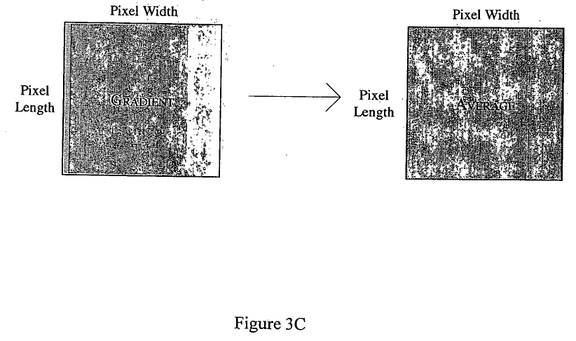

Referring now to FIGS. 3A and 3B, there is illustrated a flowchart 300 depicting a process for analyzing trends in real estate. At step 302, a user accesses the trend analysis system 100 via a client 18 to begin the process. At step 304, the trend analysis software 100 accesses a highly detailed geographical map of a particular region of interest. Preferably, a mapmaker provides aerial pictures of the targeted region in digital format to the mapping section 108. The exemplary digitally formatted map includes superimposed boundary divisions that correspond to locations or regions which represent particular types of events or features.

In addition, the digitally formatted map includes any events or features that are deemed to be relevant for the particular type of conclusions and/or predictions one seeks to gain from utilizing the trend analysis software 100. For examples relating to real estate, physical boundary lines, rivers and roadways all impact the sphere of influence of events. For an example related to crime, after the analysis of historical data, a user can begin to define the particular features or events that affect trends by noting the inconsistencies in a prediction. For example, one could implement 5 years worth of data to predict the 6^{th} years crime rates. If the 6^{th} year's crime rate is already known, a comparison can be made and in the areas of inconsistency one can find the features and events that made the predictions false (i.e., construction of schools and parks have a beneficial impact in terms of crime rate, but historical data cannot account for such changes). These features or events would need to be accounted for in future data analysis and would most likely be part of the user's analysis with the trend analysis software 100.

At step 306, a preliminary set of user-defined inputs are entered by the user to categorize the targeted element for which the user seeks to gain insight. To categorize the targeted element means to limit the analysis to events with characteristics inside a smaller range of values, thereby giving the user a more precise analysis of a specific type of event. For example, with real estate one may categorize the targeted element by selecting a type of property, square footage range, and geographic area. The preliminary set of inputs includes two types of inputs: user-defined inputs and the database inputs. Anything associated with categorizing the analysis is a user-defined input, such as the type of event. For a real estate sales example, the trend analysis system 100 anlayzes single family homes which have an area within a user-defined minimum and maximum square footage. In an alternative example of committed crimes, the analysis may be limited to only property crimes. Similar types of subdividing can be implemented generally to ensure the highest quality research that demonstrates clear patterns for specific types of events.

Additional inputs for the analysis can be read from a database of historical events, such as the values of interest and their geographic location. The selling price and location of a property sale are taken from the database such as a mutlitple listing service or assessment office. For committed crimes as the event being analyzed, the crime location and its associated costs to the department are specified by a database. Preferably, the average cost for particular crimes is based on feedback from local law enforcement agencies.

In a preferred embodiment, the preliminary set of inputs also includes a frequency and/or time period for which the data will be compiled. The data may be compiled every week, month, year, n years or the like. The user determines the time characteristic by noting the sample size to be utilized with each time period. A user may define any time period as part of the categorizing of the targeted element. However, a smaller time interval correlates to a smaller number of events. The error in such a statistical representation is the standard deviation divided by the square root of the sample size. In view of this error, a larger sample size reduces the error in a calculation. Therefore, while the user can define any time period, it is typically more accurate and, thus, desirable to have a time period that contains enough events for accurate conclusions and analysis.

Preferably, the trend analysis system 100 accounts for each event carrying influence from one time period to the next. As time progresses through the specified time period, each event's influence over the surrounding events decreases. For example, if the data is compiled monthly for one year, then those events occuring in the first month will have the weakest influence on the values of interest and density. The events occuring in the last month of the year will have the strongest influence on the surrounding region.

At step 308, a list of assumptions about the specific type of event is created by the assumption section 102 of the trend analysis system 100. The assumptions are the specific effect that relevant, measurable and accessible quantities have on the spatial decay rate of the value of interest associated with each event. Utilizing the assumptions, the construction section 104 determines the assumptions function, Aᵢ.

The assumptions function, Aᵢ is governed by the effects of the values of interest on the influence decay rate. The assumptions function, Aᵢ is based on observations and is, in the most general application, a user-defined input. Preferably, before the process 300 starts, the trend analysis system 100 assumes that the affects of higher and lower values of the value of interest will have a specific affect on the influence of an event. If no effect on an event can be found, the effect thereon goes to zero. The assumptions function, Aᵢ is based on the variation of the effect upon the values of interest as distance from the event changes. The decay of influence of the event will vary dependent upon the specific type of event, as does the assumptions function, Aᵢ.

It is envisioned that any assumptions function, Aᵢ can have multiple values of interest. Accordingly, the parameters that comprise the assumptions function, Aᵢ are selected based upon the one or more respective values of interest. The assumptions function, Aᵢ is specifically affected by the value or values of interest for each event and can become a very complex function.

If there are no assumptions on which to base a specific spatial decay rate, the trend analysis system 100 assigns the value 1 to Aᵢ. In this case, all events are assumed to have an equal decay rate for their spatial influence. As a result, the frequency of events can be represented in a density map as well as a representational mapping of the values of interest. Alternatively, if the assumptions function, Aᵢ is equal to the value of interest, as with real estate, the influence increases with a lower valued home and decreases with a higher valued home. The underlying assumption is that delapidated housing has a stronger influence on property values than elegant housing. The opposite effect occurs in the crime application since larger levels of violence would have a greater effect on the events influence. In the crime application, the assumptions function, Aᵢ would be one divided by the value of interest, or level of violence. In yet another case, the value of interest may affect the influence in some other non-linear way and the non-linear effect is accounted for within the equation of the assumptions function, Aᵢ.

At step 310, the trend analysis system 100 defines the nucleus for an event(s). The Nucleus can either be a point in space signifying the occurrence of an event at a specific location, or represent a geographic region representing the core element of the event. As applied to crime analysis, the nucleus may often be simply a singular point. As applied to real estate, properties typically contain polygonal representations of each lot or property boundary lines.

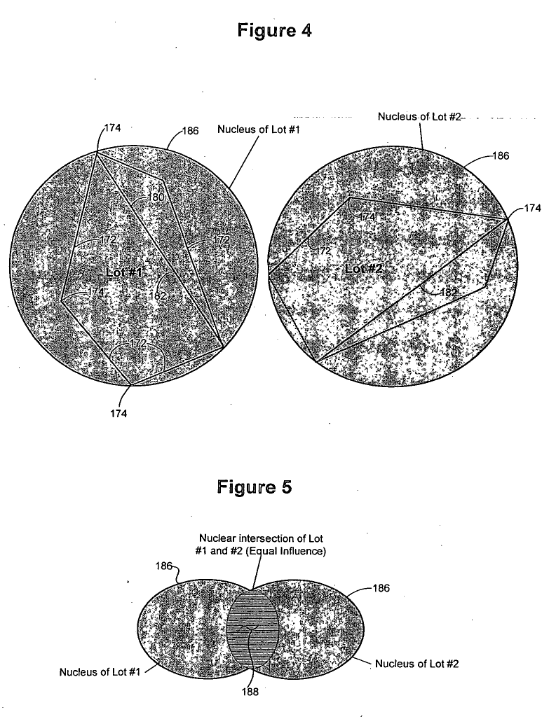

Referring now also to FIG. 4, to approximate an event with non-singular dimensions, the trend analysis system 100 calculates the radius of the nucleus, rᵢ, which would create a circle 186 with center (xᵢ, yᵢ) and area equal to the event's area (i.e. for property the event's area is ideally represented with the property's square footage). In other words, the area of the circle 186 represents the nucleus of each event.

When the trend analysis system 100 has a plurality of nucleus 186, the trend analysis system 100 accounts for the possible existence of overlapping nuclei. In this case as shown in FIG. 5, the trend analysis system 100 labels the overlapping region 188 of the nuclei, i.e., the nuclear intersection 188. In the nuclear intersection 188, the influence of each overlapping event is equal.

The particular influence of each event depends on the characteristics of the event itself, or the event's influence inside its nucleus. In one application, the event completely controls the value that is given inside its nucleus. In another application, the event's nucleus can be influenced by other events, by assigning a finite influence at the nucleus. Since every event influences other events, only in terms of the nucleus is there a user-defined quantity the Maximum Influence or MaxI of any event.

The Maximum Influence of each event is constant inside its nucleus. When MaxI is infinity, the influence inside the nucleus is infinite, and no other events have influence on the values inside. If MaxI is a finite number, then other events can influence the nuclei of surrounding events. Based upon the selection of a value for MaxI, the trend analysis system 100 assigns a particular format to a general influence function. Preferably, MaxI is a user-defined input selected as infinite or 1. If MaxI is finite, then the trend analysis system 100 may assign an influence of 1 as the value at the event's origin, or inside the event's nucleus. On the other hand, the MaxI can be selected to be a value other than 1. Preferably, the choice between a maximum influence that is infinite and finite is a user defined input based on historical observations.

At step 312, the construction section 104 of the trend analysis system 100 constructs an equation, the general influence function or GenIᵢ (x,y). The variation in each event's general influence function value is governed by the assumption function. The general influence function quantifies the influence each event has on the surrounding environment. An event's GenI value is directly related to the distance away from event. Thus, the general influence function will typically not have a negative value in most applications.

GenIᵢ (x,y) is represented by the following,

$${GenI}_{i} ( x , y ) = \{ \begin{matrix}\frac{1}{( 1 / ( MaxI + {0}_{eff} ) ) + {A}_{i} \cdot {{D}_{i} ( x , y )}^{n}} - {0}_{eff} , \sqrt{{( x - {x}_{i} )}^{2} + {( y - {y}_{i} )}^{2}} \geq {r}_{i} \\ MaxI , \sqrt{{( x - {x}_{i} )}^{2} + {( y - {y}_{i} )}^{2}} < {r}_{i}\end{matrix}$$

where:
Dᵢ(x,y)=|rᵢ−\sqrt{(x−xᵢ)²+(y−yᵢ)²}|, or the distance from the event i. Event i has a Nucleus with center (xᵢ,yᵢ) and radius rᵢ;
MaxI is the Maximum Influence of an event;
0_{eff} has a default value of ⅛, but can be altered to affect the distance at which the influence of each event becomes zero;
n has a default value of 2, but will be defined later as the reconciliation variable that has a more precise value based upon historical data;
Aᵢ is the Assumption Function; and
(x,y) is a preliminary set of inputs associated with the location of the event at step 306.

These coordinates can only be understood in terms of the calculations and the limited color representation of their values through the mediums previously discussed. These coordinates represent pixels on the mapping and each pixel represents a geographic area. In some circumstances, where the trend analysis system 100 receives addresses or GPS coordinates, the regions or points must be converted to a set of pixels. It is envisioned that the trend analysis system 100 bases calculations from a one-to-one scale sense of geography while the actual mapping will be grouping calculations together and averaging to create a less than 1-1 scale mapping.

Preferably, the trend analysis system 100 decides the resolution of the visualization when mapped. For instance, the mapping of the sales of properties includes an algorithm that can change an address into a set of x- and y-coordinates corresponding to the particular property's location on the aerial mapping described ealier. In other applications, the (x,y) coordinates are used to convert a 3-dimensional geographic region into a 2-dimensional plane on which the corresponding data can fit with less calculation. Such estimations like equating a spherical surface to a planar surface are know to those of ordinary skill in the art. One could utilize various projection algorithms to correct such discrepancies.

Preferably, the raw mapping information is detailed such that the curvature of the Earth's surface will play a part in warping the resulting mappings. Therefore, it is desirable that the maps not be defined over a large portion of the Earth. Each pixel of a map will preferably represent an average of the value of interest contributions from two or more events within the region of the pixel's area as shown in FIG. 3C. It is envisioned that the following formula is used to calculate the value at each pixel:

$$AveragePixelVal = \frac{{\int }_{{y}_{1}}^{{y}_{2}} {\int }_{{x}_{1}}^{{x}_{2}} InteriorVal ( x , y ) ⅆ x ⅆ y}{{\int }_{{y}_{1}}^{{y}_{2}} {\int }_{{x}_{1}}^{{x}_{2}} ⅆ x ⅆ y}$$

where:
x₂−x₁ equals the pixel's width in pre-converted units;
y₂−y₁ equals the pixel's length in pre-converted units as well as its width (square pixels);
InteriorVal(x,y) represents the value of interest at (x,y); and
x and y represent the coordinates before they are changed to pixels

As a result, each pixel is equal to the average of the values of interest inside the pixel's area. Because each pixel represents a finite area, the trend analysis system 100 preferably separates the change in influence inside a pixel and the corresponding changes in the values of interest in the area enclosed in a pixel. The AveragePixelVal function takes the average at each pixel after having received the complete data set for each pixel. The smaller the pixel's area, the more detailed the analysis, and vice versa. In another embodiment, the trend analysis system 100 allows zooming in and out of the maps by varying the pixel size.

Still referring to FIGS. 3A and 3B, at step 314, the mapping begins. The trend analysis system 100 creates a first set of maps to illustrate the density of the events of interest. The trend analysis system 100 accesses the set of defined nuclei 186 and the associated region in terms of x- and y-coordinates. In mapping, the trend analysis system 100 accesses data related to the occurrence of a type of event. The occurrence of each event in itself is not associated with any specific values of interest. In other words, the fact that an event occurred can be represented by the same thing each time the same type of event occurs. Therefore, because the system 100 does not consider other variables, populations, or qualities that effect the scope or strength of an event's influence in a density of events calculation, Aᵢ equals 1 for each event. This default value for the assumptions function during density of events calculations provides a simplified influence equation with each event's influence equal to the others.

Referring now to step 316, by mapping the density of the events of interest in a specified area and period of time, the trend analysis system 100 evaluates events that influence each other even inside their nucleus. This corresponds to MaxI=1. The influence of the surrounding events is represented by the following Specific Influence Function,

$${I}_{i} ( x , y ) = \{ \begin{matrix}\frac{1}{( 1 / ( 1 + {0}_{eff} ) ) + 1 \cdot {{D}_{i} ( x , y )}^{n}} - {0}_{eff} , \sqrt{{( x - {x}_{i} )}^{2} + {( y - {y}_{i} )}^{2}} \geq {r}_{i} \\ 1 , \sqrt{{( x - {x}_{i} )}^{2} + {( y - {y}_{i} )}^{2}} < {r}_{i}\end{matrix} \}$$

Suppose in a particular region of an area of interest, only one event that influences the density of events is present. Wherever the I(x,y) value, or influence, of this event is positive, the trend analysis system 100 assigns a value corresponding to having one occurrence of the type of event in the area. The following density function for a one event mapping demostrates this situation,

$$Density * ( {I}_{i} , x , y ) = \{ \begin{matrix}0 , {I}_{i} ( x , y ) \leq 0 \\ 1 , {I}_{i} ( x , y ) > 0\end{matrix}$$

When the trend analysis system 100 adds new events, the trend analysis system 100 takes into account the regions where the influences overlap and assigns an appropriate amount of value to a new function called DensityVal, or the total value given to the coloration of the pixel at any particular region on the map (in terms of its x- and y-coordinates). The DensityVal function can be written as,

$$DensityVal ( x , y , t ) = {\sum }_{i = 1}^{N} Density * ( {I}_{i} , x , y ) \cdot ( {T}_{i} ( t ) \cdot {S}_{i}^{F} ( x , y ) \cdot {I}_{i} ( x , y ) )$$

$$where \text{:}$$

$${T}_{i} ( t ) = \frac{{t}_{i}}{t} ;$$

tᵢ equals the time that event i occurred in user-defined units of time (i.e. month, year, etc.);
t is the present time in user-defined units of time; and,

$${S}_{i}^{F} ( x , y ) = \{ \begin{matrix}1 , ( x , y ) ∉ F or ( {x}_{i} , {y}_{i} ) ∈ F \\ DampI , ( x , y ) ∈ F and ( {x}_{i} , {y}_{i} ) ∉ F\end{matrix} ;$$
where DampI is a constant that weakens or nullifies the influence of event i lying inside a particular region F.

The Suppression function, Sᵢ^{F}(x,y), is for supression of an event's influence if the event occurs outside of a suppression area, but still has a positive influence inside a suppression area. For example, lets say that the set F contains the (x,y) coordinates making up a region east of a river. Property sales on the west side of the river may not influence properties on the east side. In this example, the DampI might equal 0 and any property sold on one side would not affect the opposite side. DampI is not limited to 0, as there may be a need to only slightly dampen the influence with certain barriers and features. In addition, this example is limited to only one suppression area, F, while it is envisioned that multiple areas may exist that weaken or nullify influences that come into their region.

The trend analysis system 100 calculates the density at each pixel using DensityVal function, and yields a mapping of large values for DensityVal in regions with large numbers of events. The trend analysis system 100 also yields low values for regions that have not seen many occurrences of the particular type of event. The time component, Tᵢ, allows the influence of each event to decay over time. In the assumptions section 102, the user inputs a time period for analysis as well as the frequency or units of time in which to gather information. Preferably, the trend analysis system 100 takes snapshots at each unit of time over the specified time period. The first unit of time in this user-defined time period is given a value of 1. The next unit of time gets a value of 2, the next 3, and so on until the last unit of time, t. For simplicity, the time value of zero is not used.

While the time component is described in the function above as proportional to the total time, the time component can also be described with other representations of changes in influence with respect to time. For example, in some analysis it may be more useful to have the time component decay more quickly as data farther into the past is analyzed. It would be appreciated by those of ordinary skill in the pertinent art that the trend analysis system 100 is not limited to the time component as described or the above equation, but rather the disclosure herein is a representation of the influence of time on spatial anaylsis.

Referring to FIG. 6, an exemplary top view and perspective view of possible density of event maps is shown. Referring also to FIGS. 7A-H, a series of density maps is shown to illustrate graphically a trend over a selected time period. Each FIG. 7A-H includes a map 700A-H, respectively with a coloration scheme based on the Density Val function to yield a visually useful gradient map. Following the most widely accepted coloration patterns of this type of mapping, the trend analysis system 100 preferably uses dark red to black for the highest values of Density Val and blue to white for the lowest values as shown in the legend of FIG. 7H. As a result seen in FIG. 6, the areas 600 of significant density would preferably be colored red to black for easy identification. There are many other coloration schemes that would be suitable. The choice of color depends on the particular analysis and conclusions that are represented in the specific mappings as would be appreciated by those of ordinary skill in the pertinent art.

Event Value of Interest Mapping

Referring still to FIG. 3B, at step 318, the trend analysis system 100 creates the maps illustrating the weighted value of interest over a specified region. The trend analysis system 100 assigns the appropriate Specific Influence Function by choosing between a Specific Influence Function having a finite MaxI or an infinite MaxI as deemed appropriate. The choice is based on the particular model that is desired. More specifically, the trend analysis system 100 or the user decide whether the value of interest is the most representative value for a given event's nucleus 186 or a more accurate assessment can be found through a combination of various events and their associated influences. In terms of the assumptions function, the trend analysis system 100 does not necessarily determine the exact value, but the assumptions function will typically not be 1 because of dependency upon changes on the influence of the event according to the high and low values of the associated value of interest for each event. Preferably, after the choice of MaxI is made, the trend analysis system 100 proceeds in a manner equivalent to the density of events mapping.

If in a particular region of an area of interest, only one event that influences the value of interest is present, then wherever the I value of this event is positive, the value of interest corresponding to the entire region has the specific event's value of interest as demonstrated with the following Value function for a one event mapping,

$$Value ( {I}_{i} , x , y ) = \{ \begin{matrix}{P}_{i} , {I}_{i} ( x , y ) > 0 \\ 0 , {I}_{i} ( x , y ) \leq 0\end{matrix}$$

where Pᵢ represents the value of interest of the i^{th} event.

At step 320, the non-event information is re-loaded into the picture to illustrate roads, parks, schools, rivers, lakes, and other relevant features. The non-event information is preferably included in the detailed map that is originally referenced. Next, the system 100 adds the multiple events and to arrive at the general equation.

If in another region of an area of interest there are multiple events that influence the value of interest, the trend analysis system 100 adds multiple events to the gradient map.

The trend analysis system 100 evaluates each events' influence on the area and assigns an appropriate amount of value to a new function Gradient Val, or the weighted average value of the color at any particular region on the map (in terms of its x- and y-coordinates). With a database of N events, the GradientVal can be written as,

$$GradientVal ( x , y , t ) = \frac{{\sum }_{i = 1}^{N} Value ( {I}_{i} , x , y ) \cdot ( {T}_{i} ( t ) \cdot {S}_{i}^{F} ( x , y ) \cdot {I}_{i} ( x , y ) )}{{\sum }_{i = 1}^{N} \{ \begin{matrix}{T}_{i} ( t ) \cdot {S}_{i}^{F} ( x , y ) \cdot {I}_{i} ( x , y ) , {I}_{i} ( x , y ) > 0 \\ 0 , {I}_{i} ( x , y ) \leq 0\end{matrix}}$$

In regions with high values of interest, the GradientVal function will have large values. Correspondingly, the GradientVal will have low values for regions that have lower values of interest. Setting a coloration scheme based on the GradientVal function yields the desired gradient map as would be known to those of ordinary skill in the art. Preferably, the GradientVal uses dark red to black for the highest values of interest and blue to white for the lowest values of interest. Once again, the non-event information will be re-loaded into the gradient map to illustrate the various features that also aide in the analysis of the map. For example as shown in FIGS. 7A-H, roads, highways, and city limits as well as the coloration scheme are all implemented in the 8 year period mapping while only the coloration scheme is implemented in the single time period mapping.

There exists an additional type of mapping similar to the above, but suits a criminal report more specifically. In some circumstances, the events are added together to yield an accumulation of values of interest multiplied by weight corresponding to the influence represented as follows:

$$NetGradientVal ( x , y ) = {\sum }_{i = 1}^{N} Value ( I , x , y ) \cdot {T}_{i} ( t ) \cdot {S}_{i}^{F} ( x , y ) \cdot {I}_{i} ( x , y )$$

This representation suits crime effectively this implementation yields an overall cost of law enforcement for a given area. While GradientVal can yield an average cost, NetGradientVal yields the sum of the weighted cost for all events influencing a given pixel. For example, if there are ten criminal events that influence point (x,y), the GradientVal value would be the weighted average of the cost for each of the ten events at (x,y). NetGradientVal would yield the sum of all weighted costs associated with the ten events at (x,y). Therefore, NetGradientVal gives the user a cost that more accurately reflects the total cost for enforcing the law at the point (x,y). If there are exactly ten events that influence a particular region, the region has a total cost of law enforcement equal to the sum of the costs associated with each event. Therefore, NetGradientVal is a necessary tool to accurately disperse this cost throughout the region.
Time-Sequenced Mapping

Referring now to FIGS. 7A-H, a time-sequenced map from the year 1996 to 2003 is shown and referred to generally by the reference numeral 700. The time-sequenced map 700 illustrates the growth or decline in the value of interest of a particular event in a specified region over a user-defined time period. To perform time-sequenced mapping, the trend analysis system 100 subtracts the values of the GradientVal function from one unit of time to the next yielding the change in the event's value of interest for a specific type of event over a user-defined time interval. The following equation TrendVal represents time-sequenced mapping using year as the unit of time,

$$\frac{\partial GradientVal ( x , y )}{\partial t} \{ Δ {t}_{1 - 2} \} = {TrendVal}_{Δ {t}_{1 - 2}} ( x , y ) ⇒ {TrendVal}_{Δ {t}_{1 - 2}} ( x , y ) = GradientVal ( x , y , {t}_{2} ) - GradientVal ( x , y , {t}_{1} )$$

By applying Trend Val, the trend analysis system 100 creates the maps for the sequences by subtracting these values for each pair of subsequent years at each set of x- and y-coordinates. After computing the data for each year, the derivative maps are shown in a sequence to yield the model that illustrates the growth or decline in the value of interest of a particular event in a specified region.

A similar or equivalent procedure is utilized for sequence mapping of the density of events. Subtracting the values of the DensityVal function from one year to the next yields the change in the density of events between the years. After processing the data for each year, the maps are shown in a sequence giving a convincing model that illustrates the growth or decline in the number of occurrences of a particular event.

While for the purposes of clarity we have assumed a year for the period of time that each set of data is collected, the time period may be varied. Preferably, the user specifies the time period in which the data is grouped. A smaller time period per mapping over the same total time period yields more TrendVal mappings, and, in turn, a more detailed resolution of the sequence. Typically, the increased resolution corresponds to a higher degree of accuracy in predicting trends. On the other hand, the smaller the time period, the smaller the number of new events in each mapping, which decreases the possibility to illustrate growth and decline effects. Accordingly, it is preferable for a user to select a time period as desired.

In addition, the trend analysis system 100 can generalize the derivative mapping to 2^{nd} derivative mapping, 3^{rd} derivative mapping and so on up to Y^{th} derivative mappings, where Y is based on the number of maps created. For instance, with X units of time in the user-defined time period, the trend analysis system 100 creates X maps of the event density or event value of interest. In addition, the trend analysis system 100 determines (X-1) 1^{st} derivative mapping for each type, (X-2)2^{nd} derivative mapping for each type, and 1 Y^{th} derivative mapping for each type where (X-Y)=1. It is envisioned that the number of mappings for the Y^{th} derivative maps is limited to the total number of maps created. For example, with ten maps information, up to the 9^{th} derivative mapping can be determined. Derivative mapping allows additional information on how the event characteristics will change in the future. Once a user can determine how the values of interest are changing and how the rate of change is changing, one can use the extrapolation methods described below. Preferably, the system 100 has time-sensitive data, i.e., data generated over a long period of time, and the “snapshots” in time must contain enough events to provide accurate information for the values at each pixel.

In a preferred embodiment, the trend analysis system 100 performs extrapolation. It is desirable for large extrapolations to have as many derivatives as possible. The trend analysis system 100 begins with data from one time period later, e.g., one year later. It is appreciated that the time period can be a month, day, week, etc. instead of yearly. The value of interest of a particular x- and y-coordinate in the last year of known data is used as a starting point and the last change in value of interest of known data is used to predict the following year's value of interest. Table 1 illustrates the extrapolation of a particular pixel with calculations up to the 6^{th} derivative values in year N.

TABLE 1

| | Year | Year | Year | Year | Year | Year | Year |
|---|---|---|---|---|---|---|---|
| Derivative | N | N + 1 | N + 2 | N + 3 | N + 4 | N + 5 | N + 6 |
| 0^{th} (Event value | 100 | 104 | 103 | 97 | 89 | 83 | 84 |
| of interest or | | | | | | | |
| density) | | | | | | | |
| 1^{st} | 4 | −1 | −6 | −8 | −6 | 1 | N/A |
| 2^{nd} | −5 | −5 | −2 | 2 | 7 | N/A | N/A |
| 3^{rd} | 0 | 3 | 4 | 5 | N/A | N/A | N/A |
| 4^{th} | 3 | 1 | 1 | N/A | N/A | N/A | N/A |
| 5^{th} | −2 | 0 | N/A | N/A | N/A | N/A | N/A |
| 6^{th} | 2 | N/A | N/A | N/A | N/A | N/A | N/A |

These values of Table 1 will fall off in their accuracy as the trend analysis system 100 predicts farther and farther into the future.
Mean & Standard Deviation Mapping

In a preferred embodiment, the values at each pixel of any mapping are averaged together over a number of similar mappings. For example, if ten event value of interest mappings have been created, one for each of the previous ten years, the trend analysis system 100 creates nine maps that illustrate the changes in the value of interest from year to year. The color values at each x- and y-coordinate will be averaged together for each to yield the mean change in the event value of interest. In one embodiment, the trend analysis system 100 maps the average increase or decrease in this manner, as well as the event value of interest and the rate of change in the event value of interest in a mean mapping. Preferably, the trend analysis system 100 also maps the standard deviation of such values. The availability of the mean and standard deviation maps allows a user to predict, not only the future volatility in the value of interest, but also, how the value of interest fluctuates in specific regions while staying stagnant in other areas. The following equations implements the mean and standard deviation mappings, respectively, over N derivative mappings

$${MeanTrend}_{N} ( x , y ) = ( 1 / ( N - 1 ) ) \cdot {\sum }_{i = 1}^{( N - 1 )} {TrendVal}_{Δ {t}_{i - ( i + 1 )}} ( x , y )$$

$$σ {Trend}_{N} ( x , y ) = \vert \sqrt{\begin{matrix}( 1 / ( N - 1 ) ) \cdot {\sum }_{i = 1}^{( N - 1 )} \\ {( {TrendVal}_{Δ {t}_{i - ( i + 1 )}} ( x , y ) - {MeanTrend}_{N} ( x , y ) )}^{2}\end{matrix}}$$

In view of the mean and standard deviation mapping formulas, a low σ-Trend in an area of positive MeanTrend correlates to a region that has a steady increase. On the other hand, a high σTrend value demonstrates that the region has fluctuated considerably from the average value of interest, MeanTrend, and there is less confidence in what can be predicted. In other words, the mean and standard deviation mapping gives an overall assessment of the trends associated with a targeted region. The mean and standard deviation mapping are applied to the density of events mapping to get equivalent data on the density of events trend.

Similarly, the trend analysis system 100 generalizes the mean and standard deviation mapping of the density of events by taking the Mean Trend and σtrend mappings of each of the Y^{th} derivative mappings for any accessible value of Y. Using this information, the trend analysis system 100 extrapolates curves predicting future values of interest.

In another preferred embodiment, the trend analysis system 100 computes the standard deviation of the mean, which provides a suitable range of values less than and greater than the mean value associated with a particular region. To compute the standard deviation of the mean, the trend analysis system 100 divides the σ-Trend value by the square root of the number of time periods, or samples, that the trend analysis system 100 has utilized to create the mean and standard deviation mappings. For instance, with ten years, the trend analysis system 100 has ten time periods each of which has a calculation at each set of coordinates. Therefore, a preferable range of values that the trend analysis system 100 can use accurately is the mean plus or minus the standard deviation divided by the square root of ten.

Calibration Section

Calibration of 0_{eff}

In a preferred embodiment, 0_{eff} is a user-defined constant that governs the distance at which the influence of each event becomes zero. 0_{eff} is always positive because the region of influence is finite. Large values for 0_{eff} represent a small scope of influence while small values for 0_{eff} represent a large scope of influence.

Calibrating the constant 0_{eff} to be restricted to relevant values is more helpful than leaving 0_{eff} as an unconstrained input demonstrating the scope of influence. The trend analysis system 100 constrains an influence by setting 0_{eff} equal to a value that causes the specific influence equation to produce negative values at a distance m away from an event's nucleus. In other words, an event has no influence at distances larger than m away from its nucleus. The trend analysis system 100 can calibrate 0_{eff} according to the following:

$${0}_{i}^{eff} = \frac{1}{( 1 / ( Max I + {0}_{i}^{eff} ) ) + {A}_{i} \cdot {m}^{n}} ⇒ {( {0}_{i}^{eff} )}^{2} + Max I \cdot {0}_{i}^{eff} - ( \frac{Max I}{{A}_{i} \cdot {m}^{n}} ) = 0$$

$${0}_{i}^{eff} = \{ \begin{matrix}\frac{- Max I + \sqrt{Max {I}^{2} + 4 \cdot ( \frac{Max I}{{A}_{i} \cdot {m}^{n}} )}}{2} , Max I = finite \\ \frac{1}{{A}_{i} \cdot {m}^{n}} , Max I = ∞\end{matrix} \}$$

In one embodiment, the trend analysis system 100 only calibrates 0_{eff} for the most influential events rather than for every event. Subsequently, when 0_{eff} is utilized correctly, events with weaker influence over their surrounding area render an influence of zero at a shorter distance from the nucleus than for the most influential event. Alternatively, as shown above, the calibration of 0_{eff} is done so that each event has the exact same distance away from the nucleus at which the event's influence drops below zero. In a preferred embodiment, m is set to values for particular neighborhoods, or subdivided regions of the area of interest. Utilizing the appropriately calibrated 0_{eff} values for the most influential event inside each subdivided region, the trend analysis system 100 effectively fits the event influence in localized regions.

For the quadratic solution of 0_{eff}, the trend analysis system 100 uses the positive option because 0_{eff} must be positive. By using various values for m and 0_{eff}, the trend analysis system 100 determines the scope of the influence associated with each event.

The proper calibration of 0_{eff} yields proper results. For example in some cities, neighborhoods may be isolated and an event's influence may be negligible at small distances away from its nucleus 186. These neighborhoods are close to mutually exclusive, and events that influence other events in another neighborhood do not exist. In other cases, the influence is much farther reaching and larger m values are appropriate. Preferably, the trend analysis system 100 allows the user to scroll through a spectrum of values for m to allow for variation in the events scope of influence. In this format, the user is prompted for an m value after the database inputs are updated and the trend analysis system 100 compiles the maps based on the chosen value of m and calibrated value of 0_{eff}.

Calibration of n

The calibration section 106 of the trend analysis system 100 determines the historical rate of decay of an event from the nucleus of the event or reconciliation variable n. In a preferred embodiment, the reconciliation variable n is determined by fitting the value which yields the most accurate historical data. The decay rate (e.g., n value) is fit to historical data. A plurality of methods for fitting n to the historical data are contemplated. Such methods include those used by physicists to determine that the power of gravitational attraction decays at a rate of 1/r² as would be appreciated by those of ordinary skill in the art upon review of the subject disclosure. Preferably, the trend analysis system 100 fits n to the value that is most accurate to experimentation. In the real estate example, five years of data are preferably used to predict the reconcilation variable n in the sixth year. By varying the selection on the reconcilation variable n, the trend analysis system 100 fine tunes the selection so that performance matches actual results.

Preferably, the trend analysis system 100 uses mapping of different values of the reconcilation variable n and subtracts the known values in a particular mapping. As a result, the trend analysis system 100 extrapolates final values for the reconcilation variable n and achieves a best fit mapping by noting the reconcilation variable n which has the smallest value of:

$${Error}_{n} = \sqrt{{\sum }_{∀ ( x , y )} ( {PixVal}_{i} ( x , y , {t}_{i} ) - {{IntVal}_{i} ( x , y , {t}_{i} )}^{2}}$$

where: the summation is over all relevant pixels in x and y coordinates for this value of n;
PixVal is the value associated with the pixel at the particular (x,y) using an extrapolation mapping of time tᵢ and a given value of n; and
IntVal is the actual value associated with the pixel at the particular (x,y) and at time tᵢ.

The calibration of the reconcilation variable n, preferably uses iteration. For example, if the trend analysis system 100 has ten years of historical data, the trend analysis system 100 computes ten years of mappings for each map type using the default value of the reconcilation variable n, n=2. Using the derivative mappings data from the first nine years of data, the trend analysis system 100 extrapolates the 10^{th} year's mapping. The trend analysis system 100 then computes the Error value between this extrapolated mapping and the actual mapping of the 10^{th} year. By varying the value of the reconcilation variable n between a specific range of n values, the trend analysis system 100 compares their respective Error values to locate the value of the reconcilation variable n that fits the data most precisely.

Process for Predictive Analysis of Maps

By utilizing the maps created by the trend analysis system 100, a user can review historical trends and predict future spatial trends associated with a value of interest for a particular type of event. In effect, the trend analysis system 100 determines areas where events are most likely to occur in the future. In a preferred embodiment, a user or the trend analysis system 100 can review maps of previous year's density of events and record the regions of highest density. Such review of the sequence for density of events over time indicates regions where the patterns of the number of events have shown to most likely experience growth. Further, review of the mean change in density of events mapping indicates the areas of largest average density. Still further, review of the standard deviation in density of events mapping indicates areas with the smallest variability in their changes in number of occurrences. Based upon this review, regions can be identified where the event of interest is most likely to follow predicatable occurrence patterns.

In another embodiment, the trend analysis system 100 determines areas where predictable changes in the value of interest are likely to occur. A correlation of a series of maps effectively utilizes the trend analysis system 100 for predictive analysis. First, the user or the trend analysis system 100 reviews the sequence for changes in values of interest and derivative values. Next, regions are selected based upon where the desired patterns of change in values of interest appear most likely occur. Additionally, the correlation of the series of maps includes reviewing standard deviation in value of interest mapping and highlighting areas with a low variability in their changes in value. The standard deviation in value of interest corresponds to particular ranges of the values of interest that can be linked to a level of confidence. In a criminal application, the confidence level is determined by the standard deviation. For example, if at a particular location, (x, y), the mean level of violence on a scale from 1 to 10 is 7.7 and the standard deviation is ±0.5, it is 68% likely that the level of violence is between 7.2 and 8.2, or within σ. A user of the trend analysis system 100 is 95.4% sure that the level of violence is between 6.7 and 8.7, or within 2σ and 99.7% sure that the level of violence will be between 6.2 and 9.2, or within 3σ and so on. By choosing regions that are highlighted based on criteria within each step of the above correlation, the trend analysis system 100 can determine the region(s) where the desired changes in the value of interest are most likely to occur. Preferably, the criteria are user-defined. For example, the user may be interested in the areas where the largest increase in mean level of violence takes place. In another embodiment, the user may want to determine the locations where the largest increase in the mean rate of change of the level of violence. In still another situation, the user may want to highlight only the areas where the level of violence has a low standard of deviation. In these areas, the level of violence is predictable and therefore more accurate modeling can be utilized.

In another embodiment, it is desirable to enable the trend analysis system 100 to calculate a seperate value for each location based on the compilation of the data and mappings. In still another embodiment, the trend analysis system 100 calculates a score with respect to a scale of suitability for the site selection. Such calculations entail valuing each characteristic with a percentage importance and weighting the corresponding scores with their respective importance. As a result, areas that are highly suitable and others that lack the specific desirable characteristics are identified.

It will be appreciated by those of ordinary skill in the art that the subject system and methods can provide a fundamental tool for analysis of any applicable value of interest. Preferably, use of the trend analysis system 100 is used as a predictive tool when trend analysis to the n^{th} derivative occurs based upon data that is compiled for a long period of time over small time changes in time. Extensive historical data yields a series of short term and long term extrapolations of the value of interest and n derivatives of the changes from one time period to the next. Thus, accuracy is based on assumptions of decreasing accuracy with increases in the number of time periods in the future. Additionally, the trend analysis system 100 is also used for outlining the expected changes in the density and value of interest of the events in the near future.

Generally, the trend analysis system 100 is not limited to the exemplary embodiments described herein. It is also envisioned that the trend analysis system 100 can serve as an engine for processing any data compilation. Based on the assumptions and user inputs, the data is compiled and the user can select a desired analysis. Given such data as SAT scores and the addresses or school of test takers, a user could determine the school districts in need of SAT preparatory programs or the schools where students are performing well. There are many equivalent examples of uses for the trend analysis technology where having the data in the system 100, a user can determine valuable relationships between location and values of interest. Some of these other uses include, without limitation, predictive analysis of traffic patterns, effectively predict the abundance or scarcity of resources in a specified area, or more systematically utilize particular criteria to determine whether or not to insure a particular individual with auto insurance.

To increase the accuracy of the trend analysis system 100 for various applications, it is envisioned that modification to the influence function can occur based upon the historical data as would be appreciated by those of ordinary skill in the art based upon review of the subject disclosure. Variations in the assumptions and functions can similarly be selected to optimize accuracy with respect to processing empirical data.

In still another embodiment, by creating the derivative values for each coordinate, the trend analysis system 100 extrapolates future values of interest associated with types of events as well as their density. The trend analysis system 100 also associates a specific level of confidence with each coordinate based on a similar extrapolation of the derivative values of the standard deviation of the value of interest. Thus, the decay of confidence level is reverse engineered to fit historical patterns. In this way, the trend analysis system 100 becomes a comprehensive tool to predict the occurrence of future events and the spatial trends with their associated values. Further, a user or the trend analysis system 100 can reverse engineer by recognizing historical patterns and their potential of reoccurence based upon the assumption of an increasing amount of error with predictions as analysis extends farther and farther into the future.

In another embodiment, the trend analysis system 100 is a desktop computer application that is either downloaded or provided on a compact disk. In another embodiment, the trend analysis system 100 is provided in booklet form. In still another embodiment, the trend analysis system 100 is offered as an Internet hosted application. The entity that hosts the trend analysis system 100 monitors the activity to accrue feedback related to performance and innovation.

In an alternative embodiment, the trend analysis system 100 applies to applications that do not relate spatially. For example, without limitation, the trend analysis system 100 can analyze financial equities, interest rates, geographical distribution of radon for trends and the like. In particular, the trend analysis system 100 analyzes the influence of fortune 500 stock prices on related equities over various periods and the like to allow predicting future trends based on historical performance.

It will be appreciated by those of ordinary skill in the pertinent art that the functions of several elements may, in alternative embodiments, be carried out by fewer, or single, element. Similarly, in some embodiments, any functional element may perform fewer, or different, operations than those described with respect to the illustrated embodiment. Also, functional elements (e.g., modules, databases, interfaces, computers, servers and the like) shown as distinct for purposes of illustration may be incorporated within other functional elements in a particular implementation.

While the invention has been described with respect to preferred embodiments, those skilled in the art will readily appreciate that various changes and/or modifications can be made to the invention without departing from the spirit or scope of the invention as defined by the appended claims.

1. A server for facilitating a trend analysis system, wherein the server communicates with clients via a distributed computing network, and wherein the server comprises:
(a) a memory storing an instruction set; and
(b) a processor for running the instruction set, the processor being in communication with the memory and the distributed computing network, wherein the processor is operative to:
(i) access a geographical map of a region of interest, the map including boundary divisions that represent a type of event;
(ii) receive a preliminary set of user-defined inputs to categorize the type of event;
(iii) access a database of values related to a plurality of events;
(iv) create assumptions related to the type of event, the assumptions being related to a spatial decay rate of a value of interest associated with each event;
(v) determine an assumptions variable based upon the assumptions; and
(vi) prepare a density map based upon the assumptions variable, the type of event, the geographical map, the preliminary set and the database of values, wherein the density map has large values in regions with a large numbers of events and small values in regions with a small number of events.

2. A server as recited in claim 1, wherein the geographical map includes physical boundary lines, rivers and roadways that impact a sphere of influence of the event.

3. A server as recited in claim 1, wherein the preliminary set is a type of property, a square footage range, and a geographic area.

4. A server as recited in claim 1, wherein the preliminary set includes a time period that the density map is compiled over.

5. A server as recited in claim 1, wherein the database of values includes a selling price and a location.

6. A server as recited in claim 1, wherein the database of values is a mutlitple listing service.

7. A server as recited in claim 1, wherein if the assumptions variable is equal to the value of interest, an influence for the respective event increases with a lower valued home and decreases with a higher valued home.

8. A server as recited in claim 1, wherein the processor is further operative to caclulate a general influence function for the events governed by the assumptions variable based upon the spatial decay rate.

9. A server as recited in claim 8, wherein the general influence function becomes zero outside n miles and is represented by the following values within n miles from the nucleus and inside the nucleus, respectively:
$${GenI}_{i} ( x , y ) = \frac{1}{( 1 / ( Max I + {0}_{eff} ) ) + {A}_{i} \cdot {( \sqrt{{( x - {x}_{i} )}^{2} + {( y - {y}_{i} )}^{2}} )}^{n}} - {0}_{eff} , \\ {GenI}_{i} ( {x}_{i} , {y}_{i} ) = Max I$$
where:
MaxI is a maximum influence of an event;
0_{eff} is a user-defined constant that governs a distance at which an influence of each event becomes zero;
n is a value determined based upon historical data;
Aᵢ is the assumptions variable; and
(x,y) is a preliminary set of inputs associated with a location of each event.

10. A server as recited in claim 8, wherein the processor is further operative to calculate a nucleus for each event, and determine the general influence function inside each nucleus.

11. A server as recited in claim 10, wherein the process is further operative to determine a past rate of decay of an event for the nucleus of the event.

12. A server as recited in claim 10, wherein calculating a nucleus includes:
creating a polygonal representation of each event;
computing a distance of separation for each pair of vertices for the polygonal representation; and
determining a largest value of the distances.

13. A server as recited in claim 10, wherein the processor is further operative to construct a circle on the map, the circle having a center at the event and a diameter equal to the largest value, wherein an area of the circle represents the nucleus of each event.

14. A system as recited in claim 10, wherein the processor is further operative to account for overlap in the nuclei.

15. A server as recited in claim 10, wherein the processor is further operative to determine a specific influence function based upon the plurality of nuclei.

16. A server as recited in claim 15, wherein the specific influcence function is represented by the formulas below for three different respective scenarios:
$${I}_{i} ( x , y ) = \{ \begin{matrix}\frac{1}{\begin{matrix}( 1 / ( Max I + {0}_{eff} ) ) + {A}_{i} \cdot \\ {( \vert \frac{{D}_{i}}{2} - \sqrt{{( x - {x}_{i} )}^{2} + {( y - {y}_{i} )}^{2}} \vert )}^{n}\end{matrix}} - {0}_{eff} , \sqrt{{( x - {x}_{i} )}^{2} + {( y - {y}_{i} )}^{2}} > \frac{{D}_{i}}{2} \\ Max I , \sqrt{{( x - {x}_{i} )}^{2} + {( y - {y}_{i} )}^{2}} < \frac{{D}_{i}}{2} \\ 0 \sqrt{{( x - {x}_{i} )}^{2} + {( y - {y}_{i} )}^{2}} \geq m + \frac{{D}_{i}}{2}\end{matrix}$$
where Dᵢ is the largest value and m is the distance from the perimeter of the nucleus at which the specific influence function becomes zero.

17. A server as recited in claim 10, wherein the server is further operative to evaluate an influence on an event's nucleus by the events proximal the event's nucleus.

18. A server as recited in claim 10, wherein the server is further operative to divide the density map into a plurality of pixels, and assign a coloration for each pixel based upon a density value function.

19. A server as recited in claim 18, wherein the density value function is represented by the following:
$$DensityVal ( x , y , t ) = {\sum }_{i = 1}^{N} Density * ( {I}_{i} , x , y ) \cdot ( {T}_{i} ( t ) \cdot {S}_{i}^{F} ( x , y ) \cdot {I}_{i} ( x , y ) )$$

20-22. (canceled)

23. A server as recited in claim 10, wherein the server is further operative to calibrate 0_{eff}
wherein the calibration of 0_{eff} is according to the following:
$${0}_{i}^{eff} = \frac{1}{( 1 / ( Max I + {0}_{i}^{eff} ) ) + {A}_{i} \cdot {\{ m miles \}}^{n}} ⇒ {( {0}_{i}^{eff} )}^{2} + Max I \cdot {0}_{i}^{eff} - ( \frac{Max I}{{A}_{i} \cdot {\{ m miles \}}^{n}} ) = 0$$
$${0}_{i}^{eff} = \{ \begin{matrix}\frac{- Max I + \sqrt{Max {I}^{2} + 4 \cdot ( \frac{Max I}{{A}_{i} \cdot {\{ m miles \}}^{n}} )}}{2} , Max I = finite \\ \frac{1}{{A}_{i} \cdot {\{ m miles \}}^{n}} , Max I = ∞\end{matrix} \}$$

24. A server as recited in claim 15, wherein the server is further operative to evaluate a gradient value for a region based on determination of the specific influence function for each of the events.

25. A server as recited in claim 24, wherein the gradient value is represented by the following:
$$GradientVal ( x , y , t ) = \frac{{\sum }_{i = 1}^{N} Value ( {I}_{i} , x , y ) \cdot ( {T}_{i} ( t ) \cdot {S}_{i}^{F} ( x , y ) \cdot {I}_{i} ( x , y ) )}{{\sum }_{i = 1}^{N} \{ \begin{matrix}{T}_{i} ( t ) \cdot {S}_{i}^{F} ( x , y ) \cdot {I}_{i} ( x , y ) , {I}_{i} ( x , y ) > 0 \\ 0 , {I}_{i} ( x , y ) \leq 0\end{matrix}}$$

26-33. (canceled)

34. A trend analysis system for analyzing historical data to model future trends comprising:
an assumption section for receiving data related to at least one assumption concerning an event;
a construction section for creating a plurality of variables and equations based on the at least one assumption;
a calibration section for solving for the variables; and
a mapping section for applying the equations to the historical data to generate a map indicating a spatial zone of influence within a defined time period such that a trend direction is identified.

35. (canceled)

36. A method for analyzing a trend in real estate comprising the steps of:
(a) accessing a geographical map of a region of interest, the map including boundary divisions that represent a type of event;
(b) entering a preliminary set of user-defined inputs to categorize the type of event;
(c) accessing a database of values associated with a plurality of events;
(d) creating assumptions related to the type of event, the assumptions being related to a spatial decay rate of a value of interest associated with each event;
(e) determining an assumptions variable based upon the assumptions; and
(f) caclulating a general influence function for the events governed by the assumptions variable based upon the spatial decay rate.

37-45. (canceled)
